(19) United States
(12) Patent Application Publication
(10) Pub. No.: US 2007/0041370 A1
(43) Pub. Date: Feb. 22, 2007

(54) System for Translating Electronic Communications

(76) Inventor: Aaron Cleveland, Pacific Grove, CA (US)

Correspondence Address: CENTRAL COAST PATENT AGENCY, INC, 3 HANGAR WAY SUITE D, WATSONVILLE, CA, 95076, US

(21) Appl. No.: 11/457,614

(22) Filed: Jul. 14, 2006

Related U.S. Application Data
(60) Provisional application No. 60/699,709, filed on Jul. 15, 2005.

(51) Int. Cl. H04L 12/66

(52) U.S. Cl. 370/352

(57) ABSTRACT

A messaging application having a language translation feature has a user interface for addressing the message to one or more recipients and for creating or supplying the body of the message, a first interactive list of supported language types, the list entries individually selectable via interactive method, and a second interactive list of supported language types, the list entries individually selectable. The application is characterized in that a user may interact with the first list and select a language that indicates the original language the user has used or will use to create the message and wherein the user may interact with the second list and select a language, the selected language serving as a parse able specification for a language translation engine to translate the message into the specified language.

### CROSS-REFERENCE TO RELATED APPLICATIONS

The present invention claims priority to a U.S. provisional patent application entitled “A System for Bilingual Email Communication” Ser. No. 60/699,709 filed on Jul. 15, 2005, disclosure of which is included herein at least be reference.

### BACKGROUND OF THE INVENTION

1. Field of the Invention

The present invention is in the field of electronic communication over a communications network pertaining particularly to methods for translating communications from one language to another in transit over a host network.

2. Discussion of the State of the Art

Communication over data networks between private and business persons has advanced over recent years to include many software and hardware solutions that facilitate instant communication between geographically distant entities. Electronic email and instant messaging are examples of software supported communication mediums practiced over data packet networks (DPNs). Conference bridging is an example of a hardware and software solution enabling multiparty communications. Short message service (SMS) is software that supports short text messages that are communicated to and from mobile telephones of wireless DPNs. Voice mail, Voice over Internet Protocol (VoIP) calls, network collaboration tools, chat software, and electronic message boards have been established and are used in many different communications environments.

Recent network infrastructure improvements like increased bandwidth and network segment bridging techniques have provided a virtually seamless communications environment supported by network infrastructure where a variety of communications tools can be used to communicate. The Internet and any bridged networks that can support the communications protocols or equivalents thereof are included in the supporting infrastructures along with wireless and wired telephone networks.

There are many types of services that use electronic communication techniques to enable communication between subscribers or between customers and service personnel. One type or class of service has garnered an importance so great in the market place that it has its own classification in the art. These are social networking services (SNS). A social networking service can be a relatively loosely structured or rigidly structured service that draws persons of some common interest or goal together using one or more of the electronic communications mediums described further above. A dating service is a good example of a SNS that draws persons together for the purpose of finding friends and possible mates. Much electronic communication occurs between those subscribed to a dating service and the communication and structure allowed is typically controlled somewhat by the enterprise providing the service. There are many similar SNS models currently practiced in the art. Myspace™ is one of the more successful and well-known SNS models.

One drawback to most of these services is that there is some service segregation that naturally occurs between subscribers of a large SNS due to language barriers that exist between the subscribers to the service. A large SNS based in Southern California, for example, would have a large number of Spanish speaking subscribers that do not speak or understand English. Many languages may be represented by large portions of a subscriber base who are monolingual in those languages. Some companies have attempted to address the problem by providing special areas of the service like chat rooms or other segregations where monolingual Spanish persons may interact with other monolingual Spanish persons and so on.

In other types of networking services for the business environment, the same issues might arise. For example, an enterprise whose employees communicate globally with associates may have trouble ensuring that their business dealings and transactions are understood correctly and carried out successfully because of language barriers that exist between collaborators in business. Moreover, there are multilingual individuals who have a language preference and contacts that vary widely in their language abilities.

What is clearly needed in electronic communications-based services are methods and apparatus for enabling dynamic language translations to occur between messaging, chat or communicating parties having different language speaking abilities.

### SUMMARY OF THE INVENTION

In an embodiment of the present invention a proxy language translation service integrated with one or more communications applications for translating a communiqué from an original language to one or more different languages comprising is provided, comprising a language parsing and translation engine, a mass storage repository, and at least one application program interface to the one or more communications applications.

In another embodiment a language selection menu embedded into a messaging interface for indicating a language a message is created in and for specifying a language that the message is to be translated to before delivery or access is provided, comprising a first interactive list of supported language types, the list entries individually selectable via interactive method, and a second interactive list of supported language types, the list entries individually selectable. The menu is characterized in that a user may interact with the first list and select a language that indicates the original language the user has used or will use to create the message and wherein the user may interact with the second list and select a language, once selected serves as a specification for a language translation engine to translate the message into the specified language.

In yet another embodiment a messaging application having a language translation feature is provided, comprising a user interface for addressing the message to one or more recipients and for creating or supplying the body of the message, a first interactive list of supported language types, the list entries individually selectable via interactive method, and a second interactive list of supported language types, the list entries individually selectable.

The application is characterized in that a user may interact with the first list and select a language that indicates the original language the user has used or will use to create the message and wherein the user may interact with the second list and select a language, the selected language serving as a parse able specification for a language translation engine to translate the message into the specified language.

### BRIEF DESCRIPTION OF THE DRAWING FIGURES

FIG. 1 is an architectural overview of a network supporting dynamic language translations in messaging according to an embodiment of the present invention.

FIG. 2 is a process flow chart illustrating acts for configuring a language translation while messaging according to an embodiment of the present invention.

FIG. 3 is a process flow chart illustrating acts for receiving messages in a preferred language according to an embodiment of the present invention.

FIG. 4 is an exemplary screen shot of a messaging interface supporting language translation according to an embodiment of the present invention.

FIG. 5 is an architectural overview of a bridged network supporting language translation according to an embodiment of the present invention.

FIG. 6 is a block diagram illustrating software layers of a language translating application according to an embodiment of the present invention.

FIG. 7 is a screen shot of a client messaging interface and a contact status interface adapted for language translation and configuration according to an embodiment of the present invention.

### DETAILED DESCRIPTION

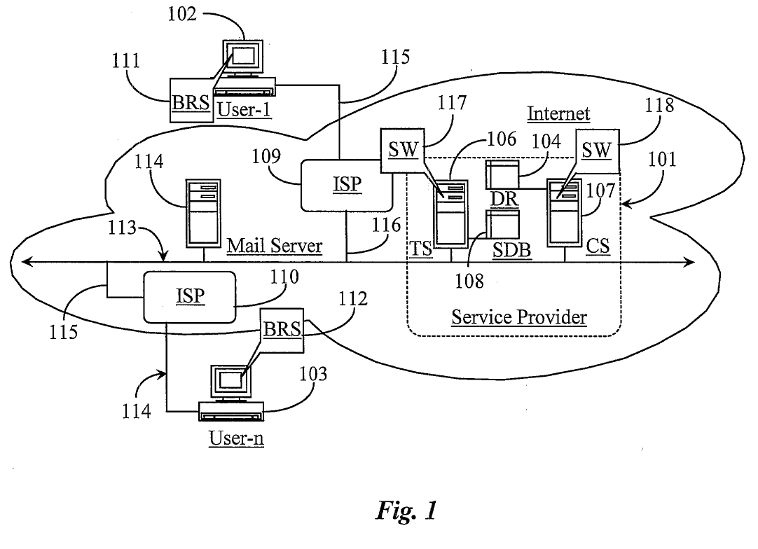

FIG. 1 is an architectural overview of a network 100 that supports dynamic language translations in electronic messaging according to an embodiment of the present invention. Network 100 is the Internet network in this example, however other communications networks and sub-networks may be used to carry electronic transmissions that may be dynamically translated from one language to another without departing from the spirit and scope of the invention. The inventor chooses network 100, which may also be referred to herein as Internet 100 because of its wide spread use in social networking. It should be noted herein as well that social networking services are not the only services that may benefit from practice of the present invention. Therefore, the example of a social networking service application provided in this specification should not be construed as a limitation to practicing the invention.

In this example, a unique messaging service is provided and embedded within a SNS, for example, such as a dating service hosted on network 100. The SNS exemplified in this example is represented logically by hardware and software, more specifically, by a contact server 107 running a software application (SW) 118 and by a translation server (TS) 106 running a software application 117. A service provider 101 having access to network 100 provides the service. The exemplified SNS may be a dating service in one embodiment that is subscribed to.

Internet 100 is further described by an Internet backbone 113, which represents all of the lines, equipment, and access points making up the network as a whole. Therefore, there are no geographic limits to the practice of the present invention. Typically, the scope of such as service will encompass subscribers who are monolingual in a number of disparate languages as well as multilingual and bilingual subscribers.

CS 107 and TS 106 are provided by and maintained by service provider 101 and have continual Internet connectivity through backbone 113. SW 117 is a language translation application running on TS 106. SW 118 is a customer contact and subscription application running on CS 107. Other servers and applications not illustrated may also be provided as required such as a customer database application and repository for billing and the like.

It happens in such a dating and social networking service introduced above that communication among subscribers is fundamental to enabling their social interaction. In many instances of interaction, two different subscribers may have different language capabilities and/or limitations. In some cases the two may speak an entirely different language, such as one being monolingual in English and the other monolingual in Spanish. It is rather common in the above case that one subscriber is principally reliant on one language, and has some ability with the other, and that the other subscriber is more reliant on the language that the first has trouble with. In such a situation, for the two people to communicate well, without serious opportunity for misunderstanding, some help needs to be provided in the language area. This is the primary problem the present invention is meant to address.

Referring again to FIG. 1, a user-1 (102) is illustrated in this example and has connectivity to Internet 100 through a telephone line 115, an Internet Service Provider (ISP) 109, and a network link 116. There are many other ways that user 102 may connect to Internet 100. A dial-up access from a telephone network is just one possible method. Digital Subscriber Line (DSL), cable modem, or wireless access represents other possible ways to connect to the services offered through service provider 101.

A user-n (103) is also illustrated in this example and has connectivity to Internet 100 through a telephone line 114, an ISP 110 and a network link 115 similar to the connectivity of user-1. User 102 and user 103 are represented in this example by desktop computer icons. However, other network capable appliances may be used to practice the present invention without departing from its spirit and scope. Any network-capable appliance with a visual display screen, input capability and a network connection may practice the invention. Examples include personal digital assistant, cellular telephone, a two-way paging device, or other similarly adapted communications devices. In one embodiment, the invention may be practiced without the requirement for a visual display. Such an embodiment will be described later in this specification.

In this example, access to the SNS provided by service provider 101 and enabled by SW 117 and SW 118 is browser based. User 102 uses an instance of network browser 111 and user 103 uses an instance of network browser 112 to access services provided by service provider 101. As service subscribers, each user may provide certain information to CS 107 during the process of becoming a subscriber to services. In this example of a dating service, the information provided may include profile information, a personal photo, and other personal information solicited by the service in order to make that information available to potential dating parties. In other types of SNSs, a different set of personal data may be provided or required. Personal information including profile, contact and billing information may be stored in a data repository (DR) 104 connected to server 107.

Users 102 and user 103 may complete registration, configuration, and activation of services through interaction with CS 107 enabled by SW 118. Once activated, translation server (TS) 106 may be used during communication between the users to provide language translation services. SW 117 enables real time and dynamic translation of asynchronous communications with the aid of some previous configuration instruction provided by users and with the aid of semantics database (SDB) 108 connected to server 106. SDB 108 may contain all of the required semantics in any number of supported languages including English and Spanish to successfully enact dynamic translation of messages between communicators using separate languages in their own interfaces.

SW 117 has a text language parser for parsing text messages received in various languages at TS 106. An instruction may be provided with received messages that SW 117 of the language the message is received in and the language the message should be translated to before forwarding the message on to the intended recipient. TS 106 is a proxy message server in one embodiment and acts as a translator for the communicators involved in a communication session through the server.

In another embodiment, TS 106 enabled by SW 117 may access a third party message server such as a mail server 114 connected to backbone 113. Access may be granted on permission of message account holders having accounts with the server. TS 106 may therefore translate messages found in the third party server for those intended recipients. In this case, the server would be provided with personal account information during service registration and configuration enabling proxy login and proxy manipulation of the third party account by server 106.

In one embodiment, users 102 and 103 use email and/or instant message (IM) clients to communicate to one another through the SNS. In one embodiment, the email and IM accounts are Web-based with no downloaded clients. In this case, all communication is carried out while the users are connected to server 106. In another embodiment, users 102 and 103 may be provided with downloadable client email and TM applications that are hard coded to practice the present invention. In still another embodiment users 102 and 103 may be provided with communications application program interfaces (APIs) so that they may adapt existing communications applications like email and IM applications for practicing the present invention. One such adaptation is the provision of an interface within the user interface of email, for example, that would allow the user to indicate which language a communiqué is prepared in and which language it should be translated in for the intended recipient. Another adaptation is an interface that allows the recipient to view a communiqué, in both languages side-by-side. More detail about such features of the present invention are provided later in this specification.

In practice according to one embodiment, user 102 may connect to server 106 with the intention to send a message to recipient user 103. User 102 may open a messaging application provided by server 106. In this case, the application executes on the server but may be used by user 102 while connected to server 106. The application may rely on instant massage access protocol (IMAP) similar to other Web-based electronic mail services. In the case of IMAP, the user does not require a local email client but may access messages and compose messages using browser 111.

User 102 may compose the message just as normal electronic email is composed, but has the option of ordering a language translation of the message from its original language to another language before the intended recipient accesses the message. This may be accomplished using a text field provided in the messaging interface that enables typed input specifying the language the message is composed in and a second field that enables typed input specifying a language that the message should be translated to.

After the message is composed, addressed to a recipient, and is pre-configured for language translation, the user may send the message by pressing a send button in the interface or by performing some keystroke operation. The message, in this case, is received by TS 106, translated according to the pre-configured specification of the sender, and is queued for the recipient. In this embodiment, TS 106 is the translation and messaging server. User 103 may at any time and from any browser-based interface, access server 106 and login to view and download messages, including those translated for the recipient. The process is of course, bi-directional.

In an embodiment wherein users 102 and 103 have local messaging clients at their stations, they may compose, address and configure messages for translation while not connected to server 106 or to Internet 100. This may also be true in the case where clients are local third party message interfaces but rely on a plug-in to enable the translation interface and feature functionality. It is noted herein that the actual interface for sending and receiving messages may take any standard and common form of an email interface, an IM interface, a chat interface, or an SMS interface without departing from the spirit and scope of the present invention. In the context of a dating service, the interface may be adapted to include features enabling profile and attribute display for both the sender and the recipient of a transaction.

Server 106 leverages SW 117 to translate the message received before it is queued up for the intended recipient. At least the prepared body of the message is translated into whatever language was ordered by the sending user via a translation engine (not illustrated) that depends on a semantic database 108 connected directly to server 106. The translation process itself may be performed in batch or per user. In batch, the server may sort all messages that require translation from say “English” to Spanish”. The server may perform such translations before queuing those messages for their recipients.

In another embodiment, user 102 may use a standard email or IM client to create a message and may send that message normally to a third patty mail server like server 114. In this case, a plug-in may enable indication of the composition language and of the desired translation language. At server 114, the sent message is queued for the intended recipient normally. Server 106 periodically checks the messages for the recipient (user 103) by proxy and can determine those that require translation. In this case the server may access those messages that require translation and may translate the message bodies of those and mark those messages unread for the recipient. This embodiment may require some cooperation from the host of server 114 for security and other reasons.

In this example, email and IM communications are referenced for dynamic translation. Those should not be construed as a limitation as other messaging applications like short message service (SMS) applications chat and Web conference application may also be provided with the translation feature of the present invention. It is also noted herein that translation may be provided by a server running software in automated fashion as described in this example or, in some cases, by a human operator or knowledge worker. Once translation is done in this particular embodiment the message in its entirety and both language versions may be stored for access by the recipient. The sender also has access to further operations, and may be informed at his/her request, whether the recipient has opened the message, not opened the message, opened and deleted, or deleted without being opened.

As described above, any subscriber may indicate to server 107 as part of activating a subscription may indicate a language in which that user wishes to receive correspondence, and also the language in which he or she will be creating messages. This input may be made a part of that subscriber's personal profile. In this way someone sending the user a message may first ascertain which language that user prefers to receive correspondence in.

When recipient 103 receives a message from user 102 the recipient may delete without opening, may open, then delete, or may open and respond, just as with many other message systems. As described further above, if recipient 103 opens the message at in the server while connected to the network the message may be viewed in both the original language with which it was created and the language as translated with guidance of server 106. Further server 106 may attach to the message information about the sender, such as, for example, a picture of the sender, and/or particular information from the sender's personal profile, such as age, financial situation, hobbies, etc.

In one embodiment of the invention, since both a sender and a receiver of a message will typically be members of (subscribers to) the service, they may both have entered language preferences for receiving correspondence. In this case there may not be a requirement for a sender then to input the language that the message should be translated to. This information will already be known to the server.

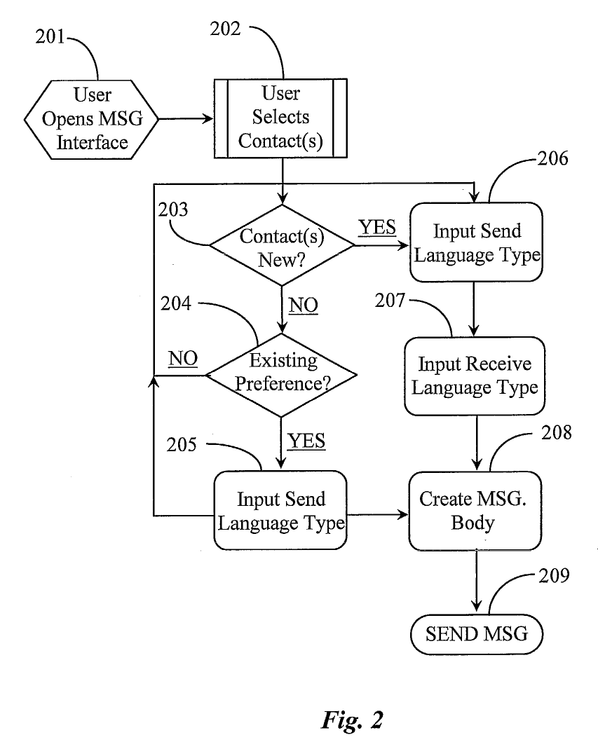

FIG. 2 is a process flow chart illustrating acts 200 for configuring a language translation while messaging according to an embodiment of the present invention. Process 200 begins at act 201 wherein a user opens a messaging (MSG) interface for the purpose of creating and then sending a message. The interface may be a local client application or a server hosted Web application provided at the server. Therefore, the user may be online and connected to the network or not depending on the interface type. Moreover, in some embodiments, the messaging interface is a SMS interface hosted on a cellular telephone having network capability.

At act 202, the user selects a contact or contacts that represent the intended recipient or recipients of the message. It is important to note herein that if there are multiple recipients of a single message, those recipients whom are subscribers and whom have indicated a default language preference for receiving correspondence shall have their message copy translated at the server according to the stated preference of that user. In this particular case, the sender need not be required to indicate all of the different language preferences manually for all of the intended recipients. It is also possible that some of the recipients in a multi-addressed communiqué are not subscribers to the service, or are subscribers but have not indicated any language preference.

Users who are not subscribers will not receive translated copies of the message. Those whom have not indicated a language preference for receiving correspondence may not receive a translated message unless the sender has manually indicated the translation language for that contact in his contact list or in the messaging interface at the time of composition of the message.

The system of the invention may help a user navigate multiple recipients of a message for language preference. Assuming the user has selected a contact or contacts to receive the message in act 202, the system may determine if the contact or particular contacts selected are new in act 203. If it is determined that they are new to the system at act 203, they may not yet be subscribers to the service and may not have indicated a default language preference known to the server or to the sending user. In this case, the sender may input a language preference for each new contact if the user knows the preferred language of the contact or contacts in question.

One purpose for the above scenario is to attract users by enabling translation of messages sent to non subscribers or new users for a limited period or a trial period. If recipients then which to have the functionality permanently they may subscribe to the service.

If at act 203, it is determined that a contact or contacts intended as recipients are not new to the system then they are known to the server and are existing subscribers. In this case, the service may determine for each contact listed as a message recipient if there is a default language preset for that recipient in which they wish to receive all correspondence. If at act 204 there is an existing language preference set by a recipient subscriber, then the user may skip directly to act 208 to create the message body. The parsing application running as part of SW 117 in server 106 may, in some embodiments, be intelligent enough to determine the send language of a message by sampling the message body text when it arrives at the server. However, requiring a user to input the send language type for each message, taking into account a large number of users, may help to reduce server processing time and steps in translating messages into other languages.

At act 205 the user may elect to type in the send language type for the message. This act is optional. It is important to note that inputting the send language type for a message is a single act regardless of how many recipients are listed. At act 209 after the message body is created in act 208, the user may send the message.

It will be apparent to the skilled artisan that a user sending a message and one or more known recipient users may be fluent in several different languages. One aspect of the present invention is to provide some flexibility for experimentation. Therefore, an act for overriding the stated preference language of a recipient may be provided after act 204 such as for inviting the particular recipient to correspond in some alternate language pair then normally would be the case. One scenario might be a user fluent in both French and German has a contact that is fluent in both Spanish and French. Since French is a language common to both users, the messages may be sent in French from both users but may be translated to Spanish for messages sent from the second user to the first user and to German for messages sent from the first user to the second user. In this way, extended correspondence between the two users may help them both to acquire a third language. Each user may view the original French message along with the translated message to help them learn the new languages. Likewise, for multilingual recipients, language preferences may be indicated based on the contacts in the recipients messaging list or address book. There are many possibilities.

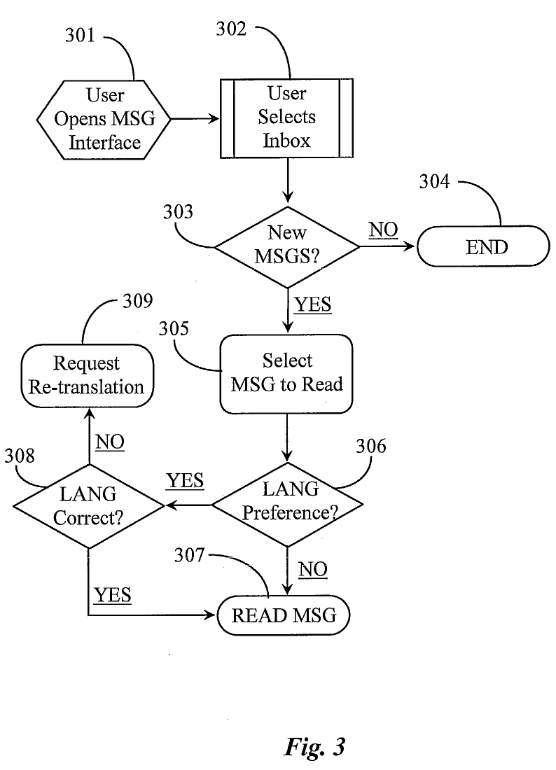

FIG. 3 is a process flow chart illustrating acts 300 for receiving messages in a preferred language according to an embodiment of the present invention. At act 301, a user opens a messaging interface. In typical practice, the user will be connected to the network when act 301 occurs. However, in the case of a local client messaging application enhanced to practice the invention, the act of opening the interface may invoke connection establishment to the network.

At act 302, the user selects the message inbox and opens it to see if there are any new messages. In another embodiment there may be an alert available to inform the user whether there are any new messages without any action required by the user accept for act 301. At act 303, if there are no new messages, then at act 304 the process ends. If at act 303 there are new unread messages, then at act 305, the recipient may select a message to read. At act 306, the server determines if there is a language preference preset for the recipient. If not, then the recipient may have received a message whereby the sender selected the translation language for the recipient. At act 307, the recipient may elect to read the message. The recipient may also perform any other typical tasks with the message such as deleting the message, moving the message, ignoring the message and so on.

At act 306, if the recipient has a language preference then the server may determine without the aid of the recipient whether the selected message is in the correct language. It may be that the sender has miscalculated by electing to translate the message in a language very close to that of the recipient but not quite the correct dialect. An example might be a comparison between Spanish and Portuguese. Therefore if for some reason the recipient had set Portuguese as the preferred language to receive all correspondence and the selected message is determined to be translated to Spanish and therefore incorrect at act 308, the recipient may optionally elect to request a retranslation to Spanish or the default language preference at act 309. In one embodiment of the invention granularity in language translating capabilities of the system may be fine tuned down to individual dialects of a same general language.

It will be apparent to the skilled artisan that process 300 may be generally tailored to an email account. This is not required in order to successfully practice the present invention. For example, a process may be enacted when an instant message is received where acts for opening an inbox and selecting a message to read are not required. In the case of instant messaging, a notification of an incoming message request automatically appears in the messaging interface and a real time correspondence may be pursued if accepted by the recipient of the invite without further notifications until a session, so established has been terminated by one of the parties. For instant messaging then, the server automatically translates the messages regardless of the original format into default languages set by message recipients in real time. A recipient may change the default setting however in mid session causing additional messages from the same sender to be translated into the new language selected by the recipient.

In this aspect, a flexibility of the present invention enables one multilingual user to chat with multiple parties receiving messages from the parties in different languages. This may be practiced simply to gain proficiency in the multiple languages. The user may also respond to the different parties using different languages.

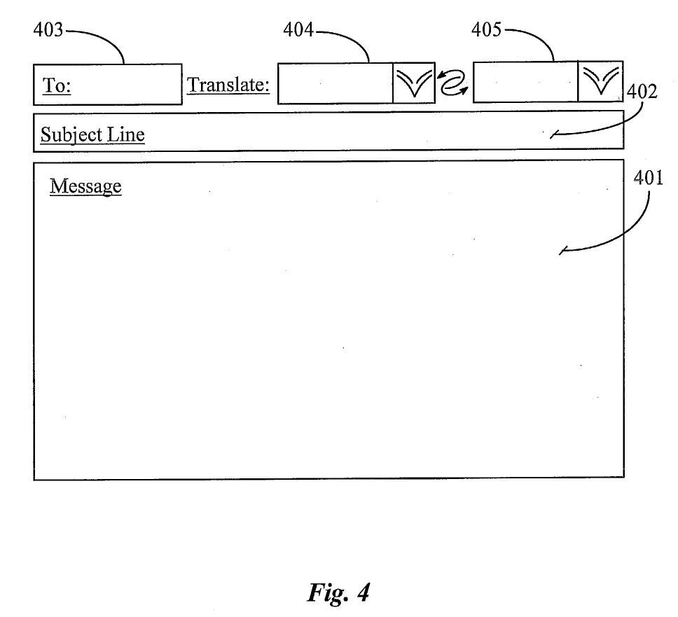

FIG. 4 is an exemplary screen shot of a messaging interface 400 supporting language translation according to an embodiment of the present invention. Interface 400 similar to an email interface in appearance. A message window 401 is provided as a field for typing the body of a message. Interface 400 has a subject field 402 for including a subject of the message. A field 403 is provided for addressing the message to a recipient. A carbon copy (CC) field and blind carbon copy (BCC) field may also be included as is the case for most email message interfaces.

Interface 400 includes a drop down menu field 404 for inputting a language type used to compose at least the message body. A second drop down menu field 405 is provided for selecting a language type that the message body will be translated to before being made accessible to the intended recipient. It may be in one embodiment that the recipient has a default language type set as the language type that all messages will be translated to. In this case, the default setting for that recipient may override any language type input into field 405.

Interface 400 take a form similar to an email interface in this example. However, the actual interface will assume the form of the normal interface for the messaging application type in actual practice. An IM interface may be very different in look and features than an email interface. An SMS interface may be very different than an email or an instant message interface. In one embodiment, features 404 and 405 may be available in any of the described interfaces. For an IM session, a user may only be required to input the language type for send at the initiation of a session (IM request). After, each message sent will automatically indicate the send language type.

In one embodiment of the present invention, voice-to-text features may be used to populate message bodies and to send messages. Also in one embodiment, voice message bodies may be submitted and may be parsed and translated to text messages or to voice synthesized messages in a specified language other than the language used to create the voice message body. In this way full voice over IP integration is supported in some embodiments. The only requirement for using the voice features is a device that supports audio and voice input and an application for transmitting the voice input to the translation server or a third party access point available to the translation server.

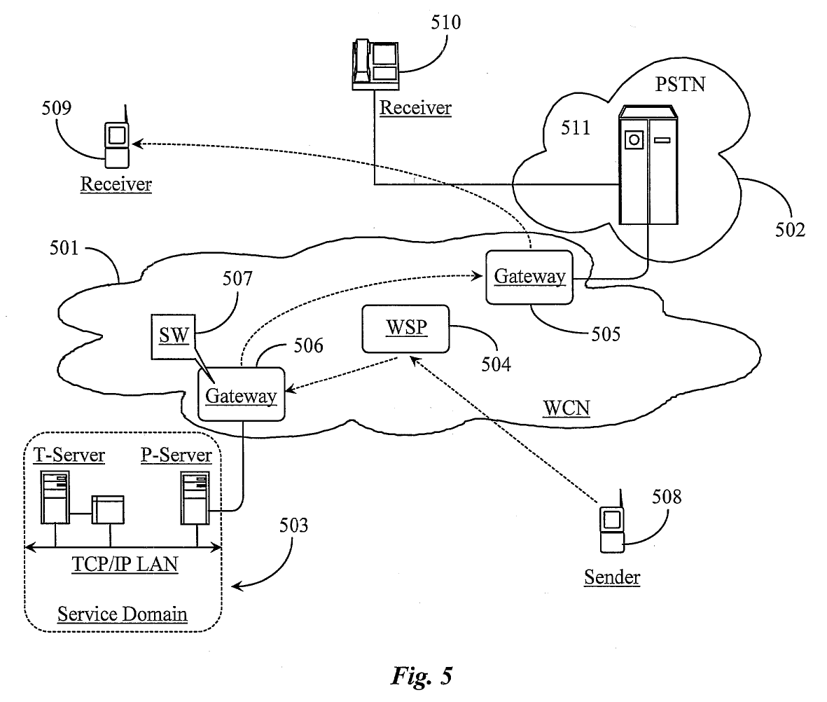

FIG. 5 is an architectural overview of a bridged network 500 supporting language translation according to another embodiment of the present invention. Network 500 includes a public switches telephone network (PSTN) 502 bridged to a wireless carrier network (WCN) 501. A service domain 503 is illustrated in this example and is also bridged to WCN 501.

PSTN 502 may be a public or private telephone network. WCN 501 may also be a public or private network. Service domain 503 includes a transfer control protocol over Internet protocol (TCP/IP) capable local area network (LAN). The LAN within service domain 503 includes a translation server (T-Server) and a proxy server (P-Server) for servicing subscribers. The SW of the present invention is assumed present and running on the LAN connected servers within service domain 503.

Service domain 503 in bridged to WCN 501 using a network gateway 506 connected directly to the LAN-connected P-server. The LAN within service domain 503 may also have connection to the Internet network although it is not specifically illustrated here. In this example, a SW application 507 is provided by the service domain 503 to gateway 506 for the purpose of extending some functionality of the present invention into WCN 501. As such, gateway 506 may be provided by and maintained by service domain 503. Service domain 503 is analogous in most respects to service provider 101 of FIG. 1.

In this example, a sender 508 is illustrated having a service connection to WCN 5-01 via a wireless service provider (WSP) 504 through subscription as is typical of wireless telephony access services. Such connectivity may include wireless call capability and wireless Internet browsing capability. Sender 508 is operating a network-capable cell phone to communicate with the service of the invention.

A wireless receiver 509 is illustrated as a second user operating a cell phone of similar description and capability as the phone operated by sender 508. Receiver 509 also has connection to WCN via WSP 504 but is not engaged in sending any messages.

PSTN 502 includes a telephone switch 511 used for routing and switching telephone calls through the network and to and from other bridged networks including WCN 501. Calls in and out of PSTN 502 are routed through gateway 505 in this example. A receiver 510 operating a standard PSTN telephone set is illustrated having a telephone connection to switch 511 for placing and receiving telephone calls. Receiver 510 may also be a subscriber to the service of the present invention.

In this example of messaging, sender 508 has a client application provided for the purpose of sending and receiving messages and that client application may be enhanced to practice the present invention. For example, sender 508 may open a messaging client while connected to WCN 501 and initiate an SMS text or other message for send to another user, perhaps receiver 509. The message may, instead of being sent directly to the telephone number of receiver 509, be sent instead to gateway 506 running SW 507 for initial routing. Gateway 506 recognizes sender 508 as a subscriber and forward the message to the LAN connected proxy server within service domain 503.

Once the message is received within service domain 503, it may be translated by the translation server according to data input by sender 508 and/or according to any preferences set by receiver 509, who is also recognized as a subscriber to the service. Once the message is properly translated, the proxy server within domain 503 forwards the translated message back to gateway 506, which routes the message to the phone of receiver 509, in this case through an additional gateway 505. Receiver 509 may optionally view both the translated message and the original message side-by-side in the local messaging client. In this case, all subscribers would at least have a service API that adapts their local messaging clients to practice the present invention. That API may by default, redirect messages requesting translation services to the service of the invention as extended to any of gateways 505 or 506, or to WSP 504 if allowed. In this way the wireless carrier or carriers involved in the routing paths of messages may determine which messages are those requesting language translations and may provide the special routing of those to the service for treatment.

In one embodiment, sender 508 may initiate a text message that requests a language translation whereby the message is intended for receiver 510 in PSTN network 502. In this case, the text message may be parsed by the service and then rendered as a synthesized voice recording that may be played to receiver 510 as a voice mail or automated voice call. In this case, sender 508 creates and sends the message as before. Gateway 506 running SW 507 recognizes the sender and receiver as subscribers and that the receiver station is, in this case, a PSTN telephone with voice mail services, for example.

The message is routed through the proxy server and is translated in the translation server to a specified language. The translation server may, if equipped with a natural language engine may parse the message body and recreate the message as a computer synthesized voice file that can be attached to an outbound telephone call and recorded in a voice message box at a third party service or on a local answering machine. In this case, the proxy server has outbound dialing software capable of placing outbound telephone calls. Gateway 506 routes the call to gateway 505 and through telephone switch 511 to the telephone of receiver 510. If receiver 509 answers the call, the message may be played automatically after a few seconds and an indication of who the message is from. The receiver may have the option of not accepting the voice message. If the receiver does not answer the telephone, the voice file may be played into a message machine or into a voice mail box accessible to the receiver 509.

With some modification of software, a user may be enabled through a cooperating third party service to send a voice telephone call from the PSTN network and to have that call translated by proxy into a text message that is then translated into another language for receipt in a text messaging interface. In this case, user 510 would be a sender and users 508 and 509 may be potential receivers. In all cases the messages are treated within service domain 503 and then forwarded to the intended recipients. In the case of sending from a voice phone, a special number may be provided for the user to call, perhaps to gateway 505 that would in that case be running a version of SW 507 and would recognize the sender and intended recipient and would rely on routing information provided by the software to forward the call to the service domain. There are many possible service models that may be provided in the spirit of a social networking service (SNS) and other models that may be provided for enterprise collaboration such as use of conferencing software, network meeting software and so on.

In one embodiment, users 507, 508, and even 510 may correspond to users connected to the Internet through service domain 503, which would in that case have an open network connection accessible through the LAN. There are many possibilities. The translation service feature of the present invention may be applied t o a SNS environment or some other communications environment where the communicators have disparate language capabilities.

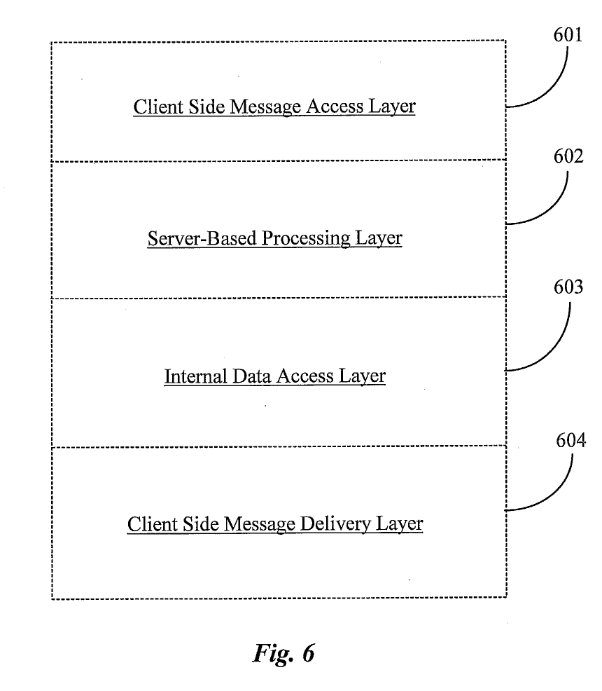

FIG. 6 is a block diagram illustrating software layers of a language translating to application 600 according to an embodiment of the present invention. Application 600 has a client message access layer 601. Layer 601 is adapted to receive messages from subscribers that are intended language translation services and subsequent delivery to one or more recipients. Access layer 601 may include buffer or queue components, and protocol handlers that may be required to successfully receive messages and/or to access messages held by third party messaging services.

Application 600 has a server-based processing layer 602 that may also be referred to as a language translation engine. Layer 602 performs formatting and translation tasks required on those messages received by or accessed by layer 601. Layer 602 cooperates with an internal data access software layer 603. Layer 603 provides the required access to a language repository containing the semantics and vocabularies for translating messages from one to another language. Layer 603 may include voice-to-text and text-to-voice software to enable generation of synthesized voice messages from text messages or for rendering voice messages into text messages for delivery to recipients.

Application 600 includes a client-side message delivery layer 604 for forwarding and in some cases generating and delivering messages to recipients after those messages have been translated and reformatted if needed for send. Layer 604 may include output buffers or queue components, protocol handlers, and/or outbound telephony dialing software if required in some embodiments. Application 600 is essentially a proxy server with a language translation component. Other layers and components may be provided to application 600 without departing from the spirit and scope of the present invention. For example, a customer relations management (CRM) component may be included for tasks like billing and service configuration tasks. In one embodiment, billing and other routine tasks not related to language translating and other messaging tasks is provided by another application in similar fashion as shown in FIG. 1.

One with skill in the art will realize that the exact components included in any of the layers of application 600 will depend at least in part on the messaging capabilities supported by the service, the architectural makeup of the supporting network environment, and the particular features and feature configuration options allowed by the enterprise hosting the application.

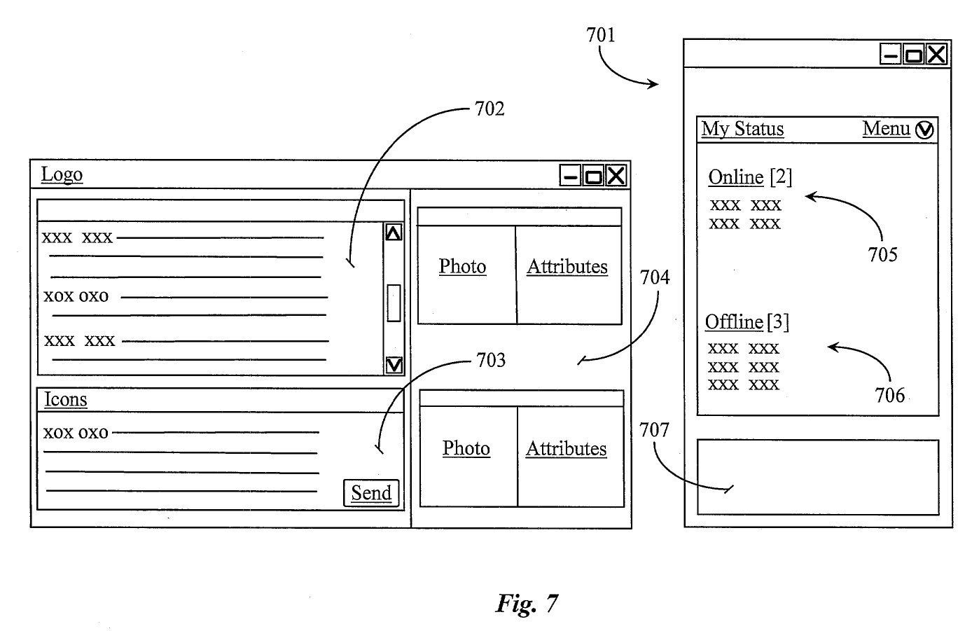

FIG. 7 is a screen shot of a client messaging interface 700 and a contact status interface 701 adapted for language translation and configuration according to another embodiment of the present invention. In one embodiment of the invention messaging interface 700 takes the form of an instant message chat interface. Interface 700 includes a title bar supporting a window minimize, a window restore, and a window close button similar to those found on most browser bars.

Interface 700 has a dialogue window 702 for viewing the chat transcripts of messages already sent and received during a session. A scroll bar capability is provided on window 702 to enable viewing or monitoring application activity. Interface 700 also has a message body creation window 703 to enable a user to create a message. A send button at the bottom portion of window 703 enable a user to send a message after it is created.

In one embodiment, window 702 presents both the original text version of a message along with the translated version of the message so that a recipient may compare the two versions. A profile window 704 is provided within interface 700 in this example on the right side of interface 700. Profile window 704 displays the photos of both the sender and receiver during a session and the attributes of those profiles including preference, height, weight, personality rating, and any other information that a subscriber may provide to the service, or that the service may garner about the subscriber. The top profile box may be attributed to the sender while the lower profile box may be that of a known recipient.

Contact status interface 701 is similar to standard interfaces used with IM programs. The interface informs the owner of his or her online or offline status as well as the current status of listed contacts or “buddies”. In this example, the user has 2 contacts (group 705) currently online and 3 contacts (group 706) listed that are currently offline. A drop down menu bar is provided containing additional features and options similar to those found in IM programs available on the market. An advertising space window 707 is also provided for receiving and displaying advertisements when online.

A unique feature may be added to each of the listed contacts in interface 701. The feature may indicate the language capabilities and preferences of each of the contacts. This feature may help the user decide which language to initiate an IM session in and which language to translate the messages in the session to for particular recipients selected from the contact interface. In one embodiment, a use might engage in more than one IM session with more than one contact simultaneously (multiple IM windows open) while using a different send language in each window. Moreover, the multiparty session messages may be translated into different languages depending on the recipient preference. Such activity may promote a goal of eventual fluency in those languages through the practice of using more than one language as a send language in separate IM windows. IM recipients may be enabled to view both the original text message and the translated message side-by-side in window 702. This feature may be turned on by default but may be turned off at any time by the recipient.

In a further embodiment, a sender may initiate a separate communication session with a correspondent while engaged in a current session having a send language and a translation language specified for that session. The new medium opened between the correspondents may be automatically configured for the same send and translation scheme. For example, user A might be in an IM session with user B. The send language of user A may be English and the language that the messages are translated to for user B may be French. If user A then initiates a shared Web browsing session with the same user B while the IM session is in progress, then user A will see the Web pages in the browser screen in English (send) and the same Web pages will appear in the browser screen of use B in French having been translated by proxy according to the default scheme used in the IM session.

It will be apparent to a skilled artisan that the examples provided in the above descriptions might be amended in a number of ways without departing from the spirit and scope of the invention. For example, the email format described is a convenience, and not a limitation. Further, although the descriptions thus far pertain to a dating service, the invention is not limited to such a service, but might be used in other messaging formats as well. There are other formats that might be used. The principle feature is the ability to translate from a sender's language of preference to a recipient's language of preference.

The methods and apparatus of the present invention may be used in a social networking environment but are not limited to such environments. Enterprise collaboration tools and Web conferencing applications may make immediate use of the features of the present invention. In one embodiment, a social networking service enhanced with the features of the present invention may be entirely Web-based the features accessible though a simple browser interface. The service may be embedded in HTML with other services such as an Internet radio player or programmable music player to provide some audio entertainment while using the service.

In other embodiments, functionality and certain features of the invention may be accessible to cellular telephones having lightweight interfaces using wireless application protocol (WAP). Features and functionality may be accessible directly from the Web interface using Flash. If the messaging applications are entirely provided to users of the service by the hosting enterprise, there may be other features packaged in with those utilities like the ability to change skins or appearance of the IM interface, for example.

Using a server-based solution to translate communicated messages may also be integrated with most types of electronic messaging including voice applications. In some embodiments, user may be provided with limited client translation abilities that can be used to translate messages locally in the background after they are received. The present invention may be practiced over any type of communications network that supports the particular protocols required to carry the messages. The invention may be practiced over several bridged networks supporting different protocols as long as the bridging facilities can properly convert the messages into formats suitable for the next network segment.

The spirit and scope of the present invention can be practiced using some of or all of the described components and elements, implementation thereof depending only on the supporting network and allowed communications mediums. The spirit and scope of the present invention is limited only by the claims that follow.

What is claimed is:

1. A proxy language translation service integrated with one or more communications applications for translating a communiqué from an original language to one or more different languages comprising:
a language parsing and translation engine;
a mass storage repository; and
at least one application program interface to the one or more communications applications.

2. A language selection menu embedded into a messaging interface for indicating a language a message is created in and for specifying a language that the message is to be translated to before delivery or access comprising:
a first interactive list of supported language types, the list entries individually selectable via interactive method; and
a second interactive list of supported language types, the list entries individually selectable;
characterized in that a user may interact with the first list and select a language that indicates the original language the user has used or will use to create the message and wherein the user may interact with the second list and select a language, once selected serves as a specification for a language translation engine to translate the message into the specified language.

3. A messaging application having a language translation feature comprising;
a user interface for addressing the message to one or more recipients and for creating or supplying the body of the message
a first interactive list of supported language types, the list entries individually selectable via interactive method; and
a second interactive list of supported language types, the list entries individually selectable;
characterized in that a user may interact with the first list and select a language that indicates the original language the user has used or will use to create the message and wherein the user may interact with the second list and select a language, the selected language serving as a parse able specification for a language translation engine to translate the message into the specified language.
